(19) United States
(12) Patent Application Publication
(10) Pub. No.: US 2017/0226937 A1
(43) Pub. Date: Aug. 10, 2017

(54) VALVE DEVICE FOR A MOTOR VEHICLE

(71) Applicant: CONTINENTAL AUTOMOTIVE GMBH, Hannover (DE)

(72) Inventors: Ralph-Joachim Eifler, Bad Hersfeld (DE); Walter Göpel, Herleshausen (DE); Peter Welteroth, Glashütten (DE)

(73) Assignee: CONTINENTAL AUTOMOTIVE GMBH, Hannover (DE)

(21) Appl. No.: 15/496,175

(22) Filed: Apr. 25, 2017

Related U.S. Application Data
(63) Continuation of application No. PCT/EP2015/074638, filed on Oct. 23, 2015.

(30) Foreign Application Priority Data
Oct. 30, 2014 (DE) 10 2014 222 240.0

(51) Int. Cl. F02D 9/10

(52) U.S. Cl. CPC F02D 9/1075

(57) ABSTRACT

The invention relates to a valve device for a motor vehicle, comprising a housing, a flow channel located in the housing, a flap arranged in the flow channel for closing the flow channel, the flap having regions in which a pin penetrating the flap is fastened and the pin being rotatably mounted in the housing, and a valve seat, which is arranged in the flow channel and which is in contact with the flap when the latter is in the closed position. The flow channel is provided with a plasma coating which renders it hydrophobic or hydrophilic.

### CROSS-REFERENCE TO RELATED APPLICATIONS

This application claims the benefit of PCT Application PCT/EP2015/074638, filed Oct. 23, 2015, which claims priority to German Application DE 10 2014 222 240.0, filed Oct. 30, 2014. The disclosures of the above applications are incorporated herein by reference.

### FIELD OF THE INVENTION

The invention relates to a valve device for a motor vehicle, which includes a housing, a flow channel located in the housing, a flap arranged in the flow channel for closing the flow channel, the flap being fastened on a shaft, and the shaft being mounted rotatably in the housing, and a valve seat, which is arranged in the flow channel and which is in contact with the flap when the flap is in the closed position.

### BACKGROUND OF THE INVENTION

Valve devices of this type are used, for example, as throttle assemblies or exhaust gas recirculation valves and have long been known. By means of the rotatably mounted flap, it is possible to close the flow channel completely or to open it in such a manner as to regulate the mass flow. In this case, ice may form in the flow channel and on the flap given unfavorable environmental conditions. Particularly in the case of a parked vehicle, when the flap is in the emergency operating position in which it releases merely a small gap in the flow channel, this position of the flap promotes the formation of ice. As a consequence of the ice formation, a uniform sequence of motion of the flap is disrupted. In the worst case, the formation of ice prevents tight closure or easy opening of the flow channel by the flap. In this respect, it is known to heat the housing of the valve device in that a channel connected to the water cooling circuit of the internal combustion engine runs around the flow channel in the housing. The cooling water thus heats the housing. A disadvantage of this valve device is the complex design of the housing as a consequence of the coolant channel with the connections connected thereto.

### SUMMARY OF THE INVENTION

The invention is based on the object of providing a valve device which minimizes the risk of ice formation in the flow channel and/or on the flap.

By virtue of the fact that the flow channel has a hydrophobic or hydrophilic configuration in that it is provided with a plasma coating, the adhesion of water and/or the formation of ice is avoided, or minimized to the extent that blocking of the flap or non-uniform movement of the flap is prevented. In this respect, it may already be sufficient that, in the case of a hydrophobic configuration, a small quantity of water leads to a non-critical formation of ice, since this ice is readily removed without adverse effects upon movement of the flap. A hydrophilic configuration also leads to this effect, since the hydrophilic surface attracts the water, which then runs off from the surface in large quantities and as a result leaves behind only a very thin film of water in the flow channel and/or on the flap which is easily be broken up upon freezing. On account of this configuration of the flow channel and/or flap, no other measures for preventing ice formation in the valve device are required. In particular, it is not necessary to provide a channel in the housing for heating the valve device. The outlay for the housing may thereby be reduced considerably. In addition, on account of the fact that there are no connections for the channel, the valve device according to the invention requires a considerably smaller installation space. For the purposes of the invention, a hydrophobic configuration is also understood to mean a superhydrophobic or icephobic configuration, and a hydrophilic configuration is also understood to mean a superhydrophilic configuration. It is similarly advantageous if the flap has a hydrophobic or hydrophilic configuration in that it is provided with a plasma coating.

A reduced outlay is achieved with the hydrophobic configuration if the plasma coating is formed on only one of the two parts. Under different conditions, however, the hydrophobic configuration of the flow channel and of the flap has proved to be expedient.

In an advantageous embodiment, the hydrophobic configuration consists in a hydrophobic coating which is applied with little outlay in the flow channel and/or the flap.

The outlay for the coating may be reduced further if only the region of the valve seat in the flow channel or the close surroundings of the region of the valve seat in the flow channel has the hydrophobic or hydrophilic plasma coating.

Likewise, the outlay for the coating may be reduced if the hydrophobic plasma coating is arranged only on one side of the flap.

Whereas a hydrophobic or hydrophilic plasma coating achieves the hydrophobic or hydrophilic effect primarily by way of the material properties of the coating, it is the case according to another embodiment that the hydrophobic or hydrophilic configuration may be produced by a nanostructured surface of the flow channel and/or of the flap.

The outlay for applying the nanostructured surface may be reduced in this respect if the flow channel has the nanostructured surface only in the region of the valve seat and/or of the flap and/or only on one side.

### BRIEF DESCRIPTION OF THE DRAWINGS

The present invention will become more fully understood from the detailed description and the accompanying drawings, wherein:

FIG. 1 is a perspective view of a valve device according to embodiments of the present invention;

FIG. 2 is a sectional view of a flow channel which is part of a valve device, according to embodiments of the present invention.

### DETAILED DESCRIPTION OF THE PREFERRED EMBODIMENTS

The following description of the preferred embodiment(s) is merely exemplary in nature and is in no way intended to limit the invention, its application, or uses.

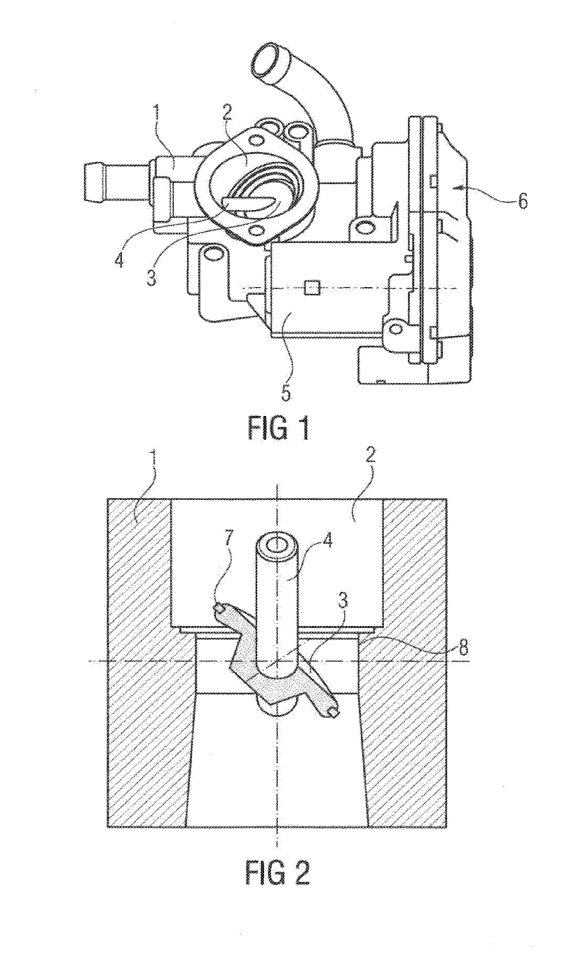

FIG. 1 shows a throttle assembly comprising a housing 1 and a flow channel 2, which is located in the housing and in which a disk-shaped flap 3 is arranged. The flap 3 is connected fixedly to a shaft 4 and the shaft 4 is mounted rotatably in the housing 1. The shaft 4 is driven by an electric motor 5 arranged in the housing 1, a transmission 6 being arranged between the shaft 4 and the electric motor 5.

FIG. 2 shows part of the flow channel 2 as shown in FIG. 1 in section. The disk-shaped flap 3 is connected fixedly in terms of rotation to the shaft 4 by means of a welded connection. In the illustration shown, the flap 3 is opened approximately half way. The seal is provided here by way of a sealing ring 7, which is arranged in a groove of the flap 3. In the closed position, the flap 3 seals off the flow channel 2. The cylindrical region, in which the flap 3 seals off the flow channel 2, is the valve seat 8. Both the cylindrical valve seat 8 and the flap 3 are provided with a hydrophobic or hydrophilic coating in that a plasma coating has been applied.

During the plasma coating, the material of the flap and/or of the valve seat is coated with thin layers which are formed by the action of a plasma on powders injected therein. For this purpose, the flap and/or the valve seat may consist of metal, for example aluminum or steel, or else of a plastic.

After very thorough cleaning, the flap and/or the valve seat may be introduced into a vacuum chamber and fixed therein, for example. Depending on the process, the chamber is evacuated until a residual gas pressure in the high-vacuum range or ultra-high-vacuum range is reached. Thereafter, a working gas (usually argon) is admitted via highly sensitive valves, and a low-pressure plasma is ignited by various energy input methods (for example microwaves, high-frequency, electrical discharge).

In addition to the working gas, it is possible for further gases (for example methane, ethyne, nitrogen) to be admitted. In the low-pressure plasma, the electrons have such high energies that chemical reactions are possible, these not being possible in thermal equilibrium. In this case, reference is made to a reactive plasma, since the reaction products are precipitated on the workpiece. Reactive plasmas may be combined with sputtering processes to form what is termed reactive sputtering.

Depending on the choice of the precursor, the injection of powders into a plasma may lead to the deposition of a hydrophobic or hydrophilic layer. In this respect, the chemical composition of the deposited layer may be influenced further by the deposition rate, the deposition angle and other parameters. It is possible to achieve layer thicknesses of 100 nm (nanometers), which may vary depending on the degree of deposition.

In the case of the plasma coating according to the invention, organosilicon compounds may be used as precursors.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A valve device for a motor vehicle, comprising:
a housing;
a shaft rotatably mounted to the housing;
a flow channel located in the housing;
a flap having an open position and a closed position, the flap arranged in the flow channel for selectively closing the flow channel, the shaft extending through the flap such that the flap is mounted to the shaft;
a valve seat arranged in the flow channel; and
a first plasma coating disposed on at least a portion of the flow channel;
wherein the flap is in contact with the valve seat when the flap is in the closed position.

2. The valve device of claim 1, the first plasma coating providing a hydrophobic characteristic to the flow channel.

3. The valve device of claim 1, the first plasma coating providing a hydrophilic characteristic to the flow channel.

4. The valve device of claim 1, further comprising a second plasma coating disposed on the flap.

5. The valve device of claim 4, the second plasma coating providing a hydrophobic characteristic to the flap.

6. The valve device of claim 4, the second plasma coating providing a hydrophilic characteristic to the flap.

7. The valve device of claim 4, wherein the second plasma coating is disposed on one side of the flap.

8. The valve device of claim 1, wherein the first plasma coating is disposed on the valve seat.

9. The valve device of claim 1, the flow channel further comprising a nanostructured surface.

10. The valve device of claim 9, the nanostructured surface of the flow channel further comprising a hydrophobic nanostructured surface.

11. The valve device of claim 9, the nanostructured surface of the flow channel further comprising a hydrophilic nanostructured surface.

12. The valve device of claim 9, the nanostructured surface the flow channel being formed as part of the valve seat.

13. The valve device of claim 1, the flap further comprising a nanostructured surface.

14. The valve device of claim 13, the nanostructured surface of the flap further comprising a hydrophobic nanostructured surface.

15. The valve device of claim 13, the nanostructured surface of the flap further comprising a hydrophilic nanostructured surface.

16. The valve device of claim 13, the nanostructured surface of the flap is disposed on one side of the flap.

17. A valve device for a motor vehicle, comprising:
a housing;
a shaft rotatably mounted to the housing;
a flow channel located in the housing;
a flap having an open position and a closed position, the flap arranged in the flow channel for selectively closing the flow channel, the shaft extending through the flap such that the flap is mounted to the shaft;
a valve seat arranged in the flow channel; and
a first plasma coating disposed on at least a portion of the flow channel such that at least a portion of the first plasma coating is disposed on the valve seat;
wherein the flap is in contact with the valve seat when the flap is in the closed position.

18. The valve device of claim 17, the first plasma coating providing a hydrophobic characteristic to the flow channel.

19. The valve device of claim 17, the first plasma coating providing a hydrophilic characteristic to the flow channel.

20. The valve device of claim 17, the flow channel further comprising a nanostructured surface, wherein the first plasma coating is applied to the nanostructured surface of the flow channel.

21. The valve device of claim 20, wherein the first plasma coating and the nanostructured surface of the flow channel provide a hydrophobic characteristic to the flow channel.

22. The valve device of claim 20, wherein the first plasma coating and the nanostructured surface of the flow channel provide a hydrophilic characteristic to the flow channel.

23. The valve device of claim 20, the nanostructured surface the flow channel being formed as part of the valve seat.

24. The valve device of claim 17, further comprising a second plasma coating disposed on the flap.

25. The valve device of claim 24, the second plasma coating providing a hydrophobic characteristic to the flap.

26. The valve device of claim 24, the second plasma coating providing a hydrophilic characteristic to the flap.

27. The valve device of claim 24, wherein the second plasma coating is disposed on one side of the flap.

28. The valve device of claim 24, the flap further comprising a nanostructured surface, wherein the second plasma coating is applied to the nanostructured surface of the flap.

29. The valve device of claim 28, wherein the second plasma coating and the nanostructured surface of the flap provide a hydrophobic characteristic to the flap.

30. The valve device of claim 28, the second plasma coating and the nanostructured surface of the flap provide a hydrophilic characteristic to the flap.

31. The valve device of claim 28, the nanostructured surface of the flap is disposed on one side of the flap.
